(19) United States
(12) Patent Application Publication
(10) Pub. No.: US 2026/0067426 A1
(43) Pub. Date: Mar. 5, 2026

(54) SYSTEM

(71) Applicant: SoftBank Group Corp., Tokyo (JP)

(72) Inventor: Hiroshi KOYAMA, Tokyo (JP)

(21) Appl. No.: 19/302,172

(22) Filed: Aug. 18, 2025

(30) Foreign Application Priority Data
Aug. 30, 2024 (JP) 2024-149734

(51) Int. Cl. H04N 7/18; G06V 10/70; G06V 20/40; G06V 20/52; G06V 40/10; G08B 21/18; H04N 23/20; H04N 23/695

(52) U.S. Cl. CPC H04N 7/181; G06V 10/70; G06V 20/40; G06V 20/52; G06V 40/10; H04N 23/695; G08B 21/182; H04N 23/20

(57) ABSTRACT

The system according to the embodiment comprises a surveillance camera, an analysis unit, and a warning unit. The surveillance camera captures the drug administration scene in real time. The analysis unit analyzes the video captured by the surveillance camera and recognizes the type and amount of the drug. The warning unit issues a warning when the administered amount exceeds a reference value based on the information recognized by the analysis unit.

### CROSS-REFERENCE TO RELATED APPLICATION

The present application claims priority to and incorporates by reference the entire contents of Japanese Patent Application No. 2024-149734 filed in Japan on Aug. 30, 2024.

### BACKGROUND OF THE INVENTION

### Field of the Invention

The technology of this disclosure relates to a system.

### Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there is a risk of human error regarding drug dosage, and there is room for improvement.

### SUMMARY OF THE INVENTION

The system according to the embodiment comprises a surveillance camera, an analysis unit, and a warning unit. The surveillance camera captures the drug administration scene in real time. The analysis unit analyzes the video captured by the surveillance camera and recognizes the type and amount of the drug. The warning unit issues a warning when the administered amount exceeds a reference value based on the information recognized by the analysis unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

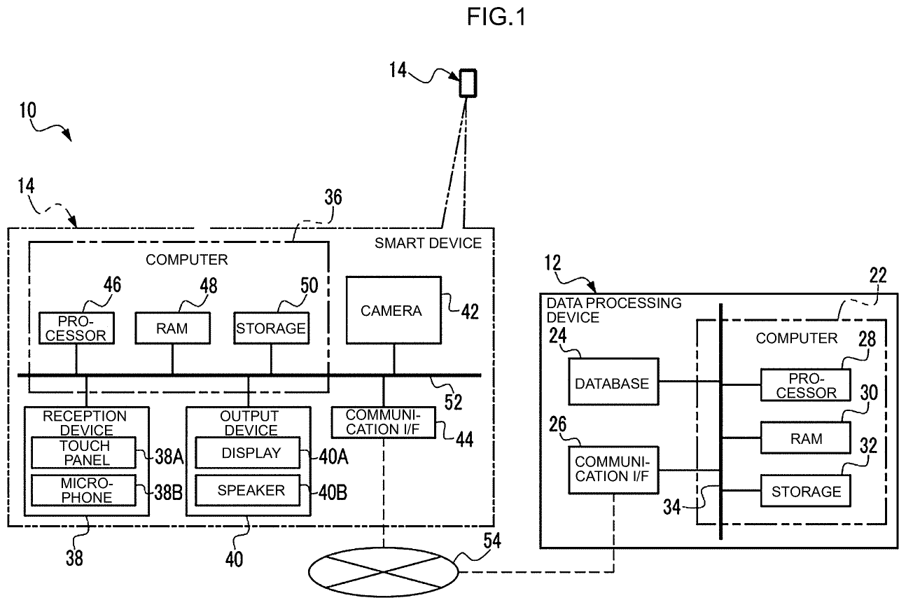

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

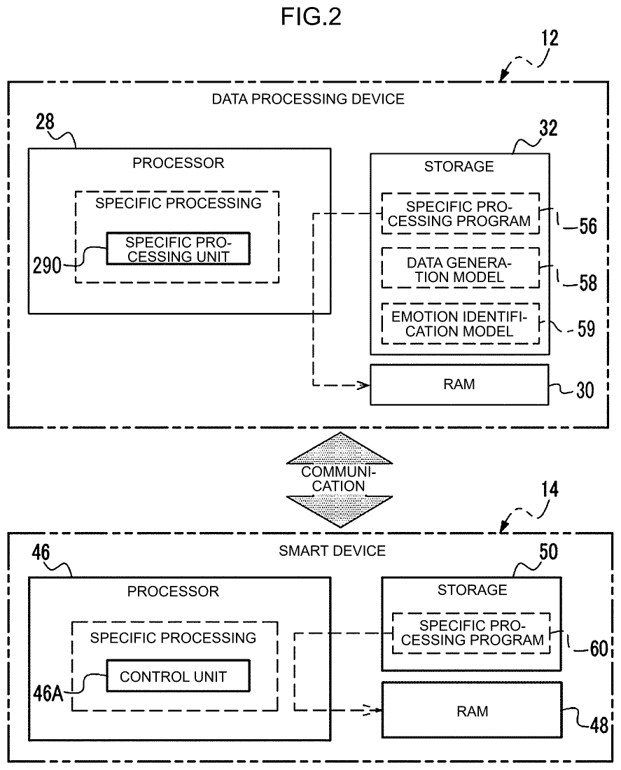

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of the Embodiment

The drug dosage monitoring system according to the embodiment of the present invention is a system that monitors drug dosage using AI to prevent human error in medical settings. This drug dosage monitoring system monitors the type and amount of drugs through a surveillance camera, and the AI analyzes that information. If the dosage is incorrect, the AI immediately issues a warning and notifies the medical staff. This prevents drug administration errors in advance and ensures the safety of both medical staff and patients. For example, the surveillance camera captures the drug administration scene in real time. This video is sent to the AI, which analyzes the type and amount of the drug. For example, the AI recognizes the drug's label, color, and shape, and calculates the dosage. Next, the AI compares the analysis result with the correct dosage set in advance. If the dosage is incorrect, the AI immediately issues a warning and notifies the medical staff. For example, it may display a warning message on a monitor or sound an alarm. With this system, medical staff can prevent drug administration errors and ensure patient safety. In addition, the burden on medical staff is reduced and work efficiency is improved. For example, even when a nurse is tired during a night shift, the AI is monitoring, so they can work with peace of mind. Furthermore, this system can be used not only in medical settings but also in pharmacies and nursing care facilities. For example, when dispensing drugs at a pharmacy, the AI monitors and prevents incorrect drugs from being prescribed. Also, when administering drugs in nursing care facilities, the AI monitors and prevents administration errors. In this way, the drug dosage monitoring system using AI is an effective means to prevent human error in medical settings and ensure the safety of both medical staff and patients. As a result, the drug dosage monitoring system can ensure the safety of medical staff and patients and prevent human error in medical settings.

The drug dosage monitoring system according to the embodiment comprises a surveillance camera, an analysis unit, and a warning unit. The surveillance camera captures the drug administration scene in real time. For example, the surveillance camera captures the drug administration scene in high resolution and generates video data. The surveillance camera can also use an infrared camera to enable shooting in dark places. For example, the surveillance camera can accurately capture the drug administration scene in dark places using an infrared camera. Furthermore, the surveillance camera can coordinate multiple cameras to obtain images from different angles. For example, the surveillance camera can coordinate multiple cameras to simultaneously obtain images from different angles and improve analysis accuracy. The analysis unit uses AI to analyze the video captured by the surveillance camera and recognizes the type and amount of the drug. For example, the analysis unit recognizes the drug's label, color, and shape, and calculates the dosage. For example, the analysis unit reads the drug label using OCR technology to identify the type of drug. The analysis unit can also analyze the drug's color and shape using image recognition technology to identify the type of drug. Furthermore, the analysis unit can also recognize the smell and texture of the drug. For example, the analysis unit uses an odor sensor to recognize the smell of the drug and improve analysis accuracy. The warning unit issues a warning when the administered amount exceeds a reference value based on the information recognized by the analysis unit. For example, the warning unit displays a warning message on a monitor. For example, when the administered amount exceeds the reference value, the warning unit displays a warning message on the monitor and notifies the medical staff. The warning unit can also sound an alarm. For example, when the administered amount exceeds the reference value, the warning unit sounds an alarm to warn the medical staff. Thus, the drug dosage monitoring system according to the embodiment can prevent drug administration errors and ensure the safety of medical staff and patients. Some or all of the above-described processing in the warning unit may be performed using AI or without using AI. For example, the warning unit can issue a warning using an AI model that takes the information recognized by the analysis unit as input and outputs a warning message. Furthermore, the warning unit can send notifications to the medical staff's smartphones or tablets. For example, the warning unit can send a warning message about an administration error to the medical staff's smartphone so that they can receive the warning immediately. This allows medical staff to respond quickly.

The surveillance camera can simultaneously capture the drug administration scene and the surrounding environment to identify the cause of administration errors. For example, the surveillance camera can capture the actions and facial expressions of medical staff at the same time as the drug administration scene to identify the cause of administration errors. The surveillance camera can also capture the patient's reactions and movements at the same time as the drug administration scene to identify the cause of administration errors. Furthermore, the surveillance camera can also capture ambient sounds and background at the same time as the drug administration scene to identify the cause of administration errors. This makes it easier to identify the cause of administration errors. Some or all of the above-described processing in the surveillance camera may be performed using AI or without using AI. For example, the surveillance camera can input the captured video data to a generative AI and have the generative AI identify the cause of administration errors.

The surveillance camera can coordinate multiple cameras to obtain images from different angles and improve analysis accuracy. For example, the surveillance camera can coordinate multiple cameras to simultaneously obtain images from different angles and improve analysis accuracy. The surveillance camera can also coordinate multiple cameras to simultaneously obtain images from different heights and improve analysis accuracy. Furthermore, the surveillance camera can coordinate multiple cameras to simultaneously obtain images from different distances and improve analysis accuracy. This improves analysis accuracy. Some or all of the above-described processing in the surveillance camera may be performed using AI or without using AI. For example, the surveillance camera can input video data obtained from multiple cameras to a generative AI and have the generative AI improve analysis accuracy.

The surveillance camera can simultaneously capture the drug administration scene and the actions of medical personnel to identify the cause of administration errors. For example, the surveillance camera can capture the hand movements of medical personnel at the same time as the drug administration scene to identify the cause of administration errors. The surveillance camera can also capture the facial expressions of medical personnel at the same time as the drug administration scene to identify the cause of administration errors. Furthermore, the surveillance camera can also capture the body movements of medical personnel at the same time as the drug administration scene to identify the cause of administration errors. This makes it easier to identify the cause of administration errors. Some or all of the above-described processing in the surveillance camera may be performed using AI or without using AI. For example, the surveillance camera can input the captured video data to a generative AI and have the generative AI identify the cause of administration errors.

The surveillance camera can use an infrared camera in combination to enable accurate shooting even in dark places. For example, the surveillance camera can use an infrared camera in combination to accurately capture the drug administration scene in dark places. The surveillance camera can also use an infrared camera in combination to accurately capture the actions of medical personnel in dark places. Furthermore, the surveillance camera can also use an infrared camera in combination to accurately capture the reactions of patients in dark places. This enables accurate shooting even in dark places. Some or all of the above-described processing in the surveillance camera may be performed using AI or without using AI. For example, the surveillance camera can input video data obtained by the infrared camera to a generative AI and improve shooting accuracy in dark places.

The analysis unit can recognize not only the drug's label, color, and shape, but also the smell and texture of the drug to improve analysis accuracy. For example, the analysis unit can recognize the smell of the drug in addition to the label, color, and shape, and improve analysis accuracy. The analysis unit can also recognize the texture of the drug in addition to the label, color, and shape, and improve analysis accuracy. Furthermore, the analysis unit can also recognize the temperature of the drug in addition to the label, color, and shape, and improve analysis accuracy. This improves analysis accuracy. Some or all of the above-described processing in the analysis unit may be performed using AI or without using AI. For example, the analysis unit can input data on the smell and texture of the drug to a generative AI and have the generative AI improve analysis accuracy.

The analysis unit can analyze not only the drug dosage but also the administration speed and timing to prevent comprehensive administration errors. For example, the analysis unit can analyze the administration speed in addition to the drug dosage to prevent comprehensive administration errors. The analysis unit can also analyze the administration timing in addition to the drug dosage to prevent comprehensive administration errors. Furthermore, the analysis unit can also analyze the administration method in addition to the drug dosage to prevent comprehensive administration errors. This enables comprehensive prevention of administration errors. Some or all of the above-described processing in the analysis unit may be performed using AI or without using AI. For example, the analysis unit can input data on administration speed and timing to a generative AI and have the generative AI prevent comprehensive administration errors.

The analysis unit can recognize not only the drug's label, color, and shape, but also the packaging and container shape of the drug to improve analysis accuracy. For example, the analysis unit can recognize the packaging of the drug in addition to the label, color, and shape, and improve analysis accuracy. The analysis unit can also recognize the container shape of the drug in addition to the label, color, and shape, and improve analysis accuracy. Furthermore, the analysis unit can also recognize the packaging material of the drug in addition to the label, color, and shape, and improve analysis accuracy. This improves analysis accuracy. Some or all of the above-described processing in the analysis unit may be performed using AI or without using AI. For example, the analysis unit can input data on the packaging and container shape of the drug to a generative AI and have the generative AI improve analysis accuracy.

The analysis unit can analyze not only the drug dosage but also the administration method and propose the optimal administration method. For example, the analysis unit can analyze the injection administration method in addition to the drug dosage and propose an appropriate administration method. The analysis unit can also analyze the oral administration method in addition to the drug dosage and propose an appropriate administration method. Furthermore, the analysis unit can also analyze the topical administration method in addition to the drug dosage and propose an appropriate administration method. This enables the proposal of an appropriate administration method. Some or all of the above-described processing in the analysis unit may be performed using AI or without using AI. For example, the analysis unit can input data on administration methods to a generative AI and have the generative AI propose the optimal administration method.

The warning unit can display not only warning messages but also specific countermeasures at the same time to support the response of medical staff. For example, the warning unit displays the correct administration method together with the warning message for an administration error. The warning unit can also display the procedure for rechecking together with the warning message for an administration error. Furthermore, the warning unit can also display the procedure for reporting to a supervisor together with the warning message for an administration error. This supports the response of medical staff. Some or all of the above-described processing in the warning unit may be performed using AI or without using AI. For example, the warning unit can input data on warning messages and countermeasures to a generative AI and have the generative AI support the response of medical staff.

The warning unit can refer to not only warning messages but also past administration error data to improve the accuracy of warnings. For example, the warning unit refers to past administration error data and issues a warning when a similar error occurs. The warning unit can also refer to past administration error data and strengthen warnings for specific drugs. Furthermore, the warning unit can also refer to past administration error data and strengthen warnings for specific medical staff. This improves the accuracy of warnings. Some or all of the above-described processing in the warning unit may be performed using AI or without using AI. For example, the warning unit can input past administration error data to a generative AI and have the generative AI improve the accuracy of warnings.

The warning unit can send notifications not only of warning messages but also to the medical staff's smartphones or tablets. For example, the warning unit sends a warning message about an administration error to the medical staff's smartphone. The warning unit can also send a warning message about an administration error to the medical staff's tablet. Furthermore, the warning unit can also send a warning message about an administration error to the medical staff's computer. This allows medical staff to receive warnings immediately. Some or all of the above-described processing in the warning unit may be performed using AI or without using AI. For example, the warning unit can input warning message data to a generative AI and send notifications to the medical staff's devices.

The warning unit can not only display warning messages but also identify the cause of administration errors and propose recurrence prevention measures. For example, the warning unit identifies the cause of the error and proposes recurrence prevention measures together with the warning message for an administration error. The warning unit can also analyze the cause of the error and propose specific improvement measures together with the warning message for an administration error. Furthermore, the warning unit can also identify the cause of the error and propose a training program together with the warning message for an administration error. This enables the proposal of recurrence prevention measures. Some or all of the above-described processing in the warning unit may be performed using AI or without using AI. For example, the warning unit can input data on the cause of the error and recurrence prevention measures to a generative AI and have the generative AI propose recurrence prevention measures.

The system can be customized for use not only in medical settings but also in multiple locations. For example, when the system is used in a medical setting, it adds functions for cooperation with medical devices. When the system is used in a pharmacy, it can add functions corresponding to the drug dispensing process. Furthermore, when the system is used in a nursing care facility, it can add functions corresponding to the work of care staff. This enables use in various locations. Some or all of the above-described processing in the system may be performed using AI or without using AI. For example, the system can input customization data for each location to a generative AI and have the generative AI perform optimal customization.

The system can provide a simplified version for home use so that it can also be used for drug administration at home. For example, when the system is used at home, it provides a simplified interface. The system can also add a home-use administration record function when used at home. Furthermore, the system can also add a home-use alarm function when used at home. This enables use at home as well. Some or all of the above-described processing in the system may be performed using AI or without using AI. For example, the system can input data for the home-use simplified version to a generative AI and have the generative AI provide the optimal simplified version.

The system according to the embodiment is not limited to the examples described above, and various modifications are possible, for example, as follows.

The analysis unit can analyze not only the drug dosage but also the administration speed and timing to prevent comprehensive administration errors. For example, the analysis unit can analyze the administration speed in addition to the drug dosage to prevent comprehensive administration errors. The analysis unit can also analyze the administration timing in addition to the drug dosage to prevent comprehensive administration errors. Furthermore, the analysis unit can also analyze the administration method in addition to the drug dosage to prevent comprehensive administration errors. This enables comprehensive prevention of administration errors. Some or all of the above-described processing in the analysis unit may be performed using AI or without using AI. For example, the analysis unit can input data on administration speed and timing to a generative AI and have the generative AI prevent comprehensive administration errors.

The analysis unit can recognize not only the drug's label, color, and shape, but also the smell and texture of the drug to improve analysis accuracy. For example, the analysis unit can recognize the smell of the drug in addition to the label, color, and shape, and improve analysis accuracy. The analysis unit can also recognize the texture of the drug in addition to the label, color, and shape, and improve analysis accuracy. Furthermore, the analysis unit can also recognize the temperature of the drug in addition to the label, color, and shape, and improve analysis accuracy. This improves analysis accuracy. Some or all of the above-described processing in the analysis unit may be performed using AI or without using AI. For example, the analysis unit can input data on the smell and texture of the drug to a generative AI and have the generative AI improve analysis accuracy.

The warning unit can display not only warning messages but also specific countermeasures at the same time to support the response of medical staff. For example, the warning unit displays the correct administration method together with the warning message for an administration error. The warning unit can also display the procedure for rechecking together with the warning message for an administration error. Furthermore, the warning unit can also display the procedure for reporting to a supervisor together with the warning message for an administration error. This supports the response of medical staff. Some or all of the above-described processing in the warning unit may be performed using AI or without using AI. For example, the warning unit can input data on warning messages and countermeasures to a generative AI and have the generative AI support the response of medical staff.

The warning unit can refer to not only warning messages but also past administration error data to improve the accuracy of warnings. For example, the warning unit refers to past administration error data and issues a warning when a similar error occurs. The warning unit can also refer to past administration error data and strengthen warnings for specific drugs. Furthermore, the warning unit can also refer to past administration error data and strengthen warnings for specific medical staff. This improves the accuracy of warnings. Some or all of the above-described processing in the warning unit may be performed using AI or without using AI. For example, the warning unit can input past administration error data to a generative AI and have the generative AI improve the accuracy of warnings.

The analysis unit can analyze not only the drug dosage but also the administration method and propose the optimal administration method. For example, the analysis unit can analyze the injection administration method in addition to the drug dosage and propose an appropriate administration method. The analysis unit can also analyze the oral administration method in addition to the drug dosage and propose an appropriate administration method. Furthermore, the analysis unit can also analyze the topical administration method in addition to the drug dosage and propose an appropriate administration method. This enables the proposal of an appropriate administration method. Some or all of the above-described processing in the analysis unit may be performed using AI or without using AI. For example, the analysis unit can input data on administration methods to a generative AI and have the generative AI propose the optimal administration method.

The analysis unit can recognize not only the drug's label, color, and shape, but also the packaging and container shape of the drug to improve analysis accuracy. For example, the analysis unit can recognize the packaging of the drug in addition to the label, color, and shape, and improve analysis accuracy. The analysis unit can also recognize the container shape of the drug in addition to the label, color, and shape, and improve analysis accuracy. Furthermore, the analysis unit can also recognize the packaging material of the drug in addition to the label, color, and shape, and improve analysis accuracy. This improves analysis accuracy. Some or all of the above-described processing in the analysis unit may be performed using AI or without using AI. For example, the analysis unit can input data on the packaging and container shape of the drug to a generative AI and have the generative AI improve analysis accuracy.

The following is a brief explanation of the process flow of Example 1 of the Embodiment.

Step 1: The surveillance camera captures the drug administration scene in real time. The surveillance camera generates high-resolution video data and can use an infrared camera to enable shooting in dark places. It is also possible to coordinate multiple cameras to obtain images from different angles.

Step 2: The analysis unit uses AI to analyze the video captured by the surveillance camera and recognizes the type and amount of the drug. The analysis unit recognizes the drug's label, color, and shape, and calculates the dosage. Furthermore, it can also recognize the smell of the drug using an odor sensor.

Step 3: The warning unit issues a warning when the administered amount exceeds a reference value based on the information recognized by the analysis unit. The warning unit can display a warning message on a monitor and sound an alarm. It is also possible to send notifications to the medical staff's smartphones or tablets.

### Example 2 of the Embodiment

The drug dosage monitoring system according to the embodiment of the present invention is a system that monitors drug dosage using AI to prevent human error in medical settings. This drug dosage monitoring system monitors the type and amount of drugs through a surveillance camera, and the AI analyzes that information. If the dosage is incorrect, the AI immediately issues a warning and notifies the medical staff. This prevents drug administration errors in advance and ensures the safety of both medical staff and patients. For example, the surveillance camera captures the drug administration scene in real time. This video is sent to the AI, which analyzes the type and amount of the drug. For example, the AI recognizes the drug's label, color, and shape, and calculates the dosage. Next, the AI compares the analysis result with the correct dosage set in advance. If the dosage is incorrect, the AI immediately issues a warning and notifies the medical staff. For example, it may display a warning message on a monitor or sound an alarm. With this system, medical staff can prevent drug administration errors and ensure patient safety. In addition, the burden on medical staff is reduced and work efficiency is improved. For example, even when a nurse is tired during a night shift, the AI is monitoring, so they can work with peace of mind. Furthermore, this system can be used not only in medical settings but also in pharmacies and nursing care facilities. For example, when dispensing drugs at a pharmacy, the AI monitors and prevents incorrect drugs from being prescribed. Also, when administering drugs in nursing care facilities, the AI monitors and prevents administration errors. In this way, the drug dosage monitoring system using AI is an effective means to prevent human error in medical settings and ensure the safety of both medical staff and patients. As a result, the drug dosage monitoring system can ensure the safety of medical staff and patients and prevent human error in medical settings.

The drug dosage monitoring system according to the embodiment comprises a surveillance camera, an analysis unit, and a warning unit. The surveillance camera captures the drug administration scene in real time. For example, the surveillance camera captures the drug administration scene in high resolution and generates video data. The surveillance camera can also use an infrared camera to enable shooting in dark places. For example, the surveillance camera can accurately capture the drug administration scene in dark places using an infrared camera. Furthermore, the surveillance camera can coordinate multiple cameras to obtain images from different angles. For example, the surveillance camera can coordinate multiple cameras to simultaneously obtain images from different angles and improve analysis accuracy. The analysis unit uses AI to analyze the video captured by the surveillance camera and recognizes the type and amount of the drug. For example, the analysis unit recognizes the drug's label, color, and shape, and calculates the dosage. For example, the analysis unit reads the drug label using OCR technology to identify the type of drug. The analysis unit can also analyze the drug's color and shape using image recognition technology to identify the type of drug. Furthermore, the analysis unit can also recognize the smell and texture of the drug. For example, the analysis unit uses an odor sensor to recognize the smell of the drug and improve analysis accuracy. The warning unit issues a warning when the administered amount exceeds a reference value based on the information recognized by the analysis unit. For example, the warning unit displays a warning message on a monitor. For example, when the administered amount exceeds the reference value, the warning unit displays a warning message on the monitor and notifies the medical staff. The warning unit can also sound an alarm. For example, when the administered amount exceeds the reference value, the warning unit sounds an alarm to warn the medical staff. Thus, the drug dosage monitoring system according to the embodiment can prevent drug administration errors and ensure the safety of medical staff and patients. Some or all of the above-described processing in the warning unit may be performed using AI or without using AI. For example, the warning unit can issue a warning using an AI model that takes the information recognized by the analysis unit as input and outputs a warning message. Furthermore, the warning unit can send notifications to the medical staff's smartphones or tablets. For example, the warning unit can send a warning message about an administration error to the medical staff's smartphone so that they can receive the warning immediately. This allows medical staff to respond quickly.

The surveillance camera can estimate the user's emotion and adjust the shooting angle appropriately based on the estimated emotion of the user. For example, if the user is nervous, the surveillance camera widens the shooting angle to make it easier to grasp the overall situation. If the user is relaxed, the surveillance camera narrows the shooting angle to focus on a specific area. Furthermore, if the user is tired, the surveillance camera can automatically adjust the shooting angle to prioritize important scenes. This enables optimal shooting according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the surveillance camera may be performed using AI or without using AI. For example, the surveillance camera can input the user's facial expression data to a generative AI and have the generative AI estimate the user's emotion.

The surveillance camera can simultaneously capture the drug administration scene and the surrounding environment to identify the cause of administration errors. For example, the surveillance camera can capture the actions and facial expressions of medical staff at the same time as the drug administration scene to identify the cause of administration errors. The surveillance camera can also capture the patient's reactions and movements at the same time as the drug administration scene to identify the cause of administration errors. Furthermore, the surveillance camera can also capture ambient sounds and background at the same time as the drug administration scene to identify the cause of administration errors. This makes it easier to identify the cause of administration errors. Some or all of the above-described processing in the surveillance camera may be performed using AI or without using AI. For example, the surveillance camera can input the captured video data to a generative AI and have the generative AI identify the cause of administration errors.

The surveillance camera can coordinate multiple cameras to obtain images from different angles and improve analysis accuracy. For example, the surveillance camera can coordinate multiple cameras to simultaneously obtain images from different angles and improve analysis accuracy. The surveillance camera can also coordinate multiple cameras to simultaneously obtain images from different heights and improve analysis accuracy. Furthermore, the surveillance camera can coordinate multiple cameras to simultaneously obtain images from different distances and improve analysis accuracy. This improves analysis accuracy. Some or all of the above-described processing in the surveillance camera may be performed using AI or without using AI. For example, the surveillance camera can input video data obtained from multiple cameras to a generative AI and have the generative AI improve analysis accuracy.

The surveillance camera can estimate the user's emotion and adjust the shooting frequency appropriately based on the estimated emotion of the user. For example, if the user is nervous, the surveillance camera increases the shooting frequency to obtain detailed images. If the user is relaxed, the surveillance camera lowers the shooting frequency to capture only the necessary scenes. Furthermore, if the user is tired, the surveillance camera can automatically adjust the shooting frequency to prioritize important scenes. This enables optimal shooting frequency according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the surveillance camera may be performed using AI or without using AI. For example, the surveillance camera can input the user's facial expression data to a generative AI and have the generative AI estimate the user's emotion.

The surveillance camera can simultaneously capture the drug administration scene and the actions of medical personnel to identify the cause of administration errors. For example, the surveillance camera can capture the hand movements of medical personnel at the same time as the drug administration scene to identify the cause of administration errors. The surveillance camera can also capture the facial expressions of medical personnel at the same time as the drug administration scene to identify the cause of administration errors. Furthermore, the surveillance camera can also capture the body movements of medical personnel at the same time as the drug administration scene to identify the cause of administration errors. This makes it easier to identify the cause of administration errors. Some or all of the above-described processing in the surveillance camera may be performed using AI or without using AI. For example, the surveillance camera can input the captured video data to a generative AI and have the generative AI identify the cause of administration errors.

The surveillance camera can use an infrared camera in combination to enable accurate shooting even in dark places. For example, the surveillance camera can use an infrared camera in combination to accurately capture the drug administration scene in dark places. The surveillance camera can also use an infrared camera in combination to accurately capture the actions of medical personnel in dark places. Furthermore, the surveillance camera can also use an infrared camera in combination to accurately capture the reactions of patients in dark places. This enables accurate shooting even in dark places. Some or all of the above-described processing in the surveillance camera may be performed using AI or without using AI. For example, the surveillance camera can input video data obtained by the infrared camera to a generative AI and improve shooting accuracy in dark places.

The analysis unit can estimate the user's emotion and adjust the display method of the analysis results appropriately based on the estimated emotion of the user. For example, if the user is nervous, the analysis unit provides a simple and highly visible display method. If the user is relaxed, the analysis unit can provide a display method that includes detailed information. Furthermore, if the user is in a hurry, the analysis unit can provide a display method that focuses on key points. This enables the optimal display method according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the analysis unit may be performed using AI or without using AI. For example, the analysis unit can input the user's facial expression data to a generative AI and have the generative AI estimate the user's emotion.

The analysis unit can recognize not only the drug's label, color, and shape, but also the smell and texture of the drug to improve analysis accuracy. For example, the analysis unit can recognize the smell of the drug in addition to the label, color, and shape, and improve analysis accuracy. The analysis unit can also recognize the texture of the drug in addition to the label, color, and shape, and improve analysis accuracy. Furthermore, the analysis unit can also recognize the temperature of the drug in addition to the label, color, and shape, and improve analysis accuracy. This improves analysis accuracy. Some or all of the above-described processing in the analysis unit may be performed using AI or without using AI. For example, the analysis unit can input data on the smell and texture of the drug to a generative AI and have the generative AI improve analysis accuracy.

The analysis unit can analyze not only the drug dosage but also the administration speed and timing to prevent comprehensive administration errors. For example, the analysis unit can analyze the administration speed in addition to the drug dosage to prevent comprehensive administration errors. The analysis unit can also analyze the administration timing in addition to the drug dosage to prevent comprehensive administration errors. Furthermore, the analysis unit can also analyze the administration method in addition to the drug dosage to prevent comprehensive administration errors. This enables comprehensive prevention of administration errors. Some or all of the above-described processing in the analysis unit may be performed using AI or without using AI. For example, the analysis unit can input data on administration speed and timing to a generative AI and have the generative AI prevent comprehensive administration errors.

The analysis unit can estimate the user's emotion and determine the appropriate priority of analysis results based on the estimated emotion of the user. For example, if the user is nervous, the analysis unit prioritizes the display of important analysis results. If the user is relaxed, the analysis unit can prioritize the display of detailed analysis results. Furthermore, if the user is in a hurry, the analysis unit can prioritize the display of analysis results that focus on key points. This enables the optimal priority to be determined according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the analysis unit may be performed using AI or without using AI. For example, the analysis unit can input the user's facial expression data to a generative AI and have the generative AI estimate the user's emotion.

The analysis unit can recognize not only the drug's label, color, and shape, but also the packaging and container shape of the drug to improve analysis accuracy. For example, the analysis unit can recognize the packaging of the drug in addition to the label, color, and shape, and improve analysis accuracy. The analysis unit can also recognize the container shape of the drug in addition to the label, color, and shape, and improve analysis accuracy. Furthermore, the analysis unit can also recognize the packaging material of the drug in addition to the label, color, and shape, and improve analysis accuracy. This improves analysis accuracy. Some or all of the above-described processing in the analysis unit may be performed using AI or without using AI. For example, the analysis unit can input data on the packaging and container shape of the drug to a generative AI and have the generative AI improve analysis accuracy.

The analysis unit can analyze not only the drug dosage but also the administration method and propose the optimal administration method. For example, the analysis unit can analyze the injection administration method in addition to the drug dosage and propose an appropriate administration method. The analysis unit can also analyze the oral administration method in addition to the drug dosage and propose an appropriate administration method. Furthermore, the analysis unit can also analyze the topical administration method in addition to the drug dosage and propose an appropriate administration method. This enables the proposal of an appropriate administration method. Some or all of the above-described processing in the analysis unit may be performed using AI or without using AI. For example, the analysis unit can input data on administration methods to a generative AI and have the generative AI propose the optimal administration method.

The warning unit can estimate the user's emotion and adjust the display method of the warning message appropriately based on the estimated emotion of the user. For example, if the user is nervous, the warning unit displays a simple and highly visible warning message. If the user is relaxed, the warning unit can display a warning message that includes detailed information. Furthermore, if the user is in a hurry, the warning unit can display a warning message that focuses on key points. This enables the optimal warning message to be displayed according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the warning unit may be performed using AI or without using AI. For example, the warning unit can input the user's facial expression data to a generative AI and have the generative AI estimate the user's emotion.

The warning unit can display not only warning messages but also specific countermeasures at the same time to support the response of medical staff. For example, the warning unit displays the correct administration method together with the warning message for an administration error. The warning unit can also display the procedure for rechecking together with the warning message for an administration error. Furthermore, the warning unit can also display the procedure for reporting to a supervisor together with the warning message for an administration error. This supports the response of medical staff. Some or all of the above-described processing in the warning unit may be performed using AI or without using AI. For example, the warning unit can input data on warning messages and countermeasures to a generative AI and have the generative AI support the response of medical staff.

The warning unit can refer to not only warning messages but also past administration error data to improve the accuracy of warnings. For example, the warning unit refers to past administration error data and issues a warning when a similar error occurs. The warning unit can also refer to past administration error data and strengthen warnings for specific drugs. Furthermore, the warning unit can also refer to past administration error data and strengthen warnings for specific medical staff. This improves the accuracy of warnings. Some or all of the above-described processing in the warning unit may be performed using AI or without using AI. For example, the warning unit can input past administration error data to a generative AI and have the generative AI improve the accuracy of warnings.

The warning unit can estimate the user's emotion and adjust the type and volume of the warning sound appropriately based on the estimated emotion of the user. For example, if the user is nervous, the warning unit issues a warning with a calm sound. If the user is relaxed, the warning unit can issue a warning with a bright sound. Furthermore, if the user is in a hurry, the warning unit can issue a warning with a quick and concise sound. This enables the optimal warning sound to be issued according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the warning unit may be performed using AI or without using AI. For example, the warning unit can input the user's facial expression data to a generative AI and have the generative AI estimate the user's emotion.

The warning unit can send notifications not only of warning messages but also to the medical staff's smartphones or tablets. For example, the warning unit sends a warning message about an administration error to the medical staff's smartphone. The warning unit can also send a warning message about an administration error to the medical staff's tablet. Furthermore, the warning unit can also send a warning message about an administration error to the medical staff's computer. This allows medical staff to receive warnings immediately. Some or all of the above-described processing in the warning unit may be performed using AI or without using AI. For example, the warning unit can input warning message data to a generative AI and send notifications to the medical staff's devices.

The warning unit can not only display warning messages but also identify the cause of administration errors and propose recurrence prevention measures. For example, the warning unit identifies the cause of the error and proposes recurrence prevention measures together with the warning message for an administration error. The warning unit can also analyze the cause of the error and propose specific improvement measures together with the warning message for an administration error. Furthermore, the warning unit can also identify the cause of the error and propose a training program together with the warning message for an administration error. This enables the proposal of recurrence prevention measures. Some or all of the above-described processing in the warning unit may be performed using AI or without using AI. For example, the warning unit can input data on the cause of the error and recurrence prevention measures to a generative AI and have the generative AI propose recurrence prevention measures.

The system can be customized for use not only in medical settings but also in multiple locations. For example, when the system is used in a medical setting, it adds functions for cooperation with medical devices. When the system is used in a pharmacy, it can add functions corresponding to the drug dispensing process. Furthermore, when the system is used in a nursing care facility, it can add functions corresponding to the work of care staff. This enables use in various locations. Some or all of the above-described processing in the system may be performed using AI or without using AI. For example, the system can input customization data for each location to a generative AI and have the generative AI perform optimal customization.

The system can provide a simplified version for home use so that it can also be used for drug administration at home. For example, when the system is used at home, it provides a simplified interface. The system can also add a home-use administration record function when used at home. Furthermore, the system can also add a home-use alarm function when used at home. This enables use at home as well. Some or all of the above-described processing in the system may be performed using AI or without using AI. For example, the system can input data for the home-use simplified version to a generative AI and have the generative AI provide the optimal simplified version.

### ===Hardware Guarantee 1-1===

Each of the above-described elements, including the surveillance camera, analysis unit, and warning unit, is implemented, for example, by at least one of the smart device 14 and the data processing device 12. For example, the surveillance camera is implemented by the camera 42 of the smart device 14 and captures the drug administration scene in real time. The analysis unit is implemented, for example, by the specific processing unit 290 of the data processing device 12 and analyzes the video using AI to recognize the type and amount of the drug. The warning unit is implemented, for example, by the control unit 46A of the smart device 14 and displays a warning message when the administered amount exceeds the reference value.

### ===Hardware Guarantee 1-2===

Each of the above-described elements, including the surveillance camera, analysis unit, and warning unit, is implemented, for example, by at least one of the smart glasses 214 and the data processing device 12. For example, the surveillance camera is implemented by the camera 42 of the smart glasses 214 and captures the drug administration scene in real time. The analysis unit is implemented, for example, by the specific processing unit 290 of the data processing device 12 and analyzes the video using AI to recognize the type and amount of the drug. The warning unit is implemented, for example, by the control unit 46A of the smart glasses 214 and displays a warning message when the administered amount exceeds the reference value.

### ===Hardware Guarantee 1-3===

Each of the above-described elements, including the surveillance camera, analysis unit, and warning unit, is implemented, for example, by at least one of the headset-type terminal 314 and the data processing device 12. For example, the surveillance camera is implemented by the camera 42 of the headset-type terminal 314 and captures the drug administration scene in real time. The analysis unit is implemented, for example, by the specific processing unit 290 of the data processing device 12 and analyzes the video using AI to recognize the type and amount of the drug. The warning unit is implemented, for example, by the control unit 46A of the headset-type terminal 314 and displays a warning message when the administered amount exceeds the reference value.

### ===Hardware Guarantee 1-4===

Each of the above-described elements, including the surveillance camera, analysis unit, and warning unit, is implemented, for example, by at least one of the robot 414 and the data processing device 12. For example, the surveillance camera is implemented by the camera 42 of the robot 414 and captures the drug administration scene in real time. The analysis unit is implemented, for example, by the specific processing unit 290 of the data processing device 12 and analyzes the video using AI to recognize the type and amount of the drug. The warning unit is implemented, for example, by the control unit 46A of the robot 414 and displays a warning message when the administered amount exceeds the reference value.

The system according to the embodiment is not limited to the examples described above, and various modifications are possible, for example, as follows.

The analysis unit can analyze not only the drug dosage but also the administration speed and timing to prevent comprehensive administration errors. For example, the analysis unit can analyze the administration speed in addition to the drug dosage to prevent comprehensive administration errors. The analysis unit can also analyze the administration timing in addition to the drug dosage to prevent comprehensive administration errors. Furthermore, the analysis unit can also analyze the administration method in addition to the drug dosage to prevent comprehensive administration errors. This enables comprehensive prevention of administration errors. Some or all of the above-described processing in the analysis unit may be performed using AI or without using AI. For example, the analysis unit can input data on administration speed and timing to a generative AI and have the generative AI prevent comprehensive administration errors.

The warning unit can estimate the user's emotion and adjust the type and volume of the warning sound appropriately based on the estimated emotion of the user. For example, if the user is nervous, the warning unit issues a warning with a calm sound. If the user is relaxed, the warning unit can issue a warning with a bright sound. Furthermore, if the user is in a hurry, the warning unit can issue a warning with a quick and concise sound. This enables the optimal warning sound to be issued according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the warning unit may be performed using AI or without using AI. For example, the warning unit can input the user's facial expression data to a generative AI and have the generative AI estimate the user's emotion.

The analysis unit can recognize not only the drug's label, color, and shape, but also the smell and texture of the drug to improve analysis accuracy. For example, the analysis unit can recognize the smell of the drug in addition to the label, color, and shape, and improve analysis accuracy. The analysis unit can also recognize the texture of the drug in addition to the label, color, and shape, and improve analysis accuracy. Furthermore, the analysis unit can also recognize the temperature of the drug in addition to the label, color, and shape, and improve analysis accuracy. This improves analysis accuracy. Some or all of the above-described processing in the analysis unit may be performed using AI or without using AI. For example, the analysis unit can input data on the smell and texture of the drug to a generative AI and have the generative AI improve analysis accuracy.

The warning unit can display not only warning messages but also specific countermeasures at the same time to support the response of medical staff. For example, the warning unit displays the correct administration method together with the warning message for an administration error. The warning unit can also display the procedure for rechecking together with the warning message for an administration error. Furthermore, the warning unit can also display the procedure for reporting to a supervisor together with the warning message for an administration error. This supports the response of medical staff. Some or all of the above-described processing in the warning unit may be performed using AI or without using AI. For example, the warning unit can input data on warning messages and countermeasures to a generative AI and have the generative AI support the response of medical staff.

The analysis unit can estimate the user's emotion and adjust the display method of the analysis results appropriately based on the estimated emotion of the user. For example, if the user is nervous, the analysis unit provides a simple and highly visible display method. If the user is relaxed, the analysis unit can provide a display method that includes detailed information. Furthermore, if the user is in a hurry, the analysis unit can provide a display method that focuses on key points. This enables the optimal display method according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the analysis unit may be performed using AI or without using AI. For example, the analysis unit can input the user's facial expression data to a generative AI and have the generative AI estimate the user's emotion.

The warning unit can refer to not only warning messages but also past administration error data to improve the accuracy of warnings. For example, the warning unit refers to past administration error data and issues a warning when a similar error occurs. The warning unit can also refer to past administration error data and strengthen warnings for specific drugs. Furthermore, the warning unit can also refer to past administration error data and strengthen warnings for specific medical staff. This improves the accuracy of warnings. Some or all of the above-described processing in the warning unit may be performed using AI or without using AI. For example, the warning unit can input past administration error data to a generative AI and have the generative AI improve the accuracy of warnings.

The analysis unit can analyze not only the drug dosage but also the administration method and propose the optimal administration method. For example, the analysis unit can analyze the injection administration method in addition to the drug dosage and propose an appropriate administration method. The analysis unit can also analyze the oral administration method in addition to the drug dosage and propose an appropriate administration method. Furthermore, the analysis unit can also analyze the topical administration method in addition to the drug dosage and propose an appropriate administration method. This enables the proposal of an appropriate administration method. Some or all of the above-described processing in the analysis unit may be performed using AI or without using AI. For example, the analysis unit can input data on administration methods to a generative AI and have the generative AI propose the optimal administration method.

The warning unit can estimate the user's emotion and adjust the display method of the warning message appropriately based on the estimated emotion of the user. For example, if the user is nervous, the warning unit displays a simple and highly visible warning message. If the user is relaxed, the warning unit can display a warning message that includes detailed information. Furthermore, if the user is in a hurry, the warning unit can display a warning message that focuses on key points. This enables the optimal warning message to be displayed according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the warning unit may be performed using AI or without using AI. For example, the warning unit can input the user's facial expression data to a generative AI and have the generative AI estimate the user's emotion.

The analysis unit can recognize not only the drug's label, color, and shape, but also the packaging and container shape of the drug to improve analysis accuracy. For example, the analysis unit can recognize the packaging of the drug in addition to the label, color, and shape, and improve analysis accuracy. The analysis unit can also recognize the container shape of the drug in addition to the label, color, and shape, and improve analysis accuracy. Furthermore, the analysis unit can also recognize the packaging material of the drug in addition to the label, color, and shape, and improve analysis accuracy. This improves analysis accuracy. Some or all of the above-described processing in the analysis unit may be performed using AI or without using AI. For example, the analysis unit can input data on the packaging and container shape of the drug to a generative AI and have the generative AI improve analysis accuracy.

The warning unit can estimate the user's emotion and adjust the display method of the warning message appropriately based on the estimated emotion of the user. For example, if the user is nervous, the warning unit displays a simple and highly visible warning message. If the user is relaxed, the warning unit can display a warning message that includes detailed information. Furthermore, if the user is in a hurry, the warning unit can display a warning message that focuses on key points. This enables the optimal warning message to be displayed according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the warning unit may be performed using AI or without using AI. For example, the warning unit can input the user's facial expression data to a generative AI and have the generative AI estimate the user's emotion.

The following is a brief explanation of the process flow of Example 2 of the Embodiment.

Step 1: The surveillance camera captures the drug administration scene in real time. The surveillance camera generates high-resolution video data and can use an infrared camera to enable shooting in dark places. It is also possible to coordinate multiple cameras to obtain images from different angles.

Step 2: The analysis unit uses AI to analyze the video captured by the surveillance camera and recognizes the type and amount of the drug. The analysis unit recognizes the drug's label, color, and shape, and calculates the dosage. Furthermore, it can also recognize the smell of the drug using an odor sensor.

Step 3: The warning unit issues a warning when the administered amount exceeds a reference value based on the information recognized by the analysis unit. The warning unit can display a warning message on a monitor and sound an alarm. It is also possible to send notifications to the medical staff's smartphones or tablets.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

The correspondence between each unit and the devices or control units is not limited to the examples described above and various modifications are possible.

### Second Embodiment

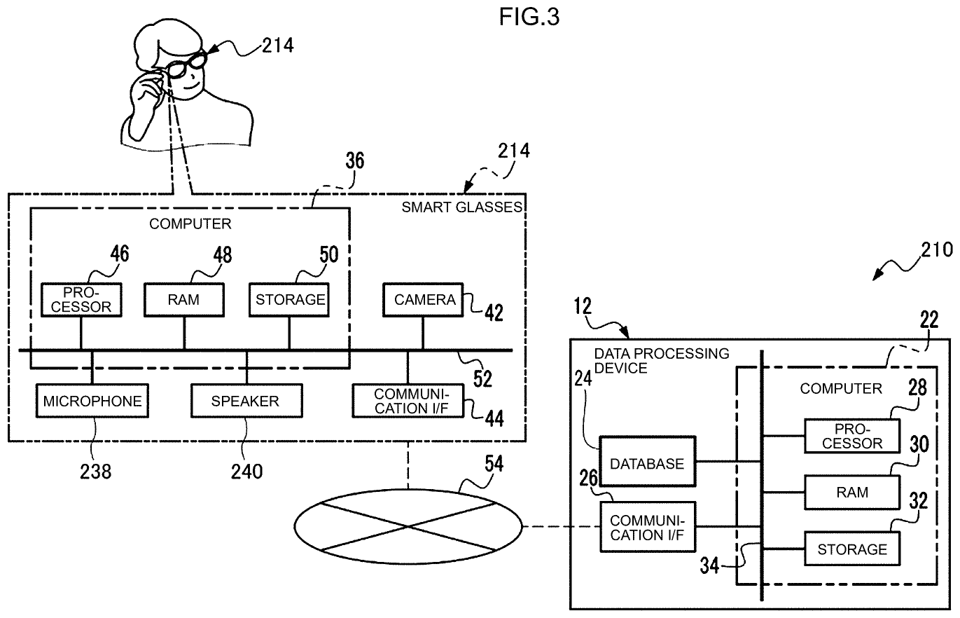

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

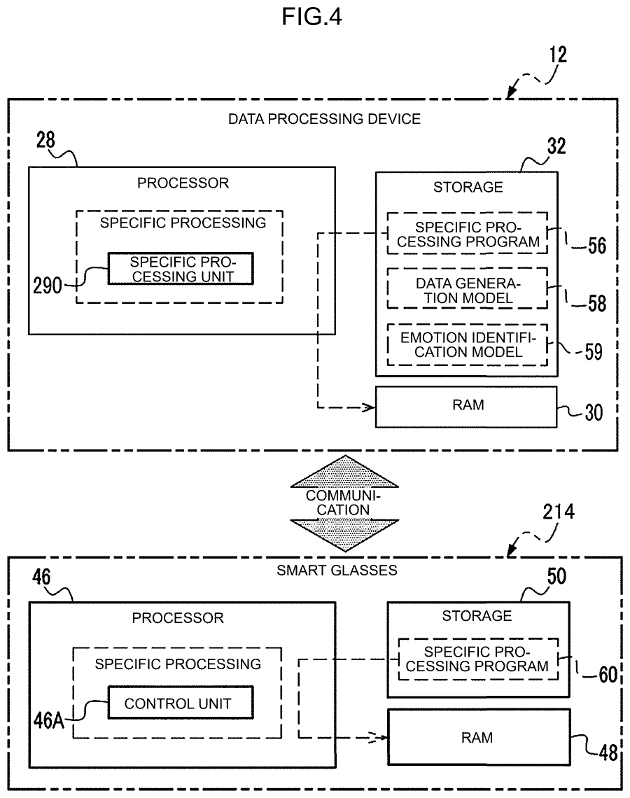

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

The correspondence between each unit and the devices or control units is not limited to the examples described above and various modifications are possible.

### Third Embodiment

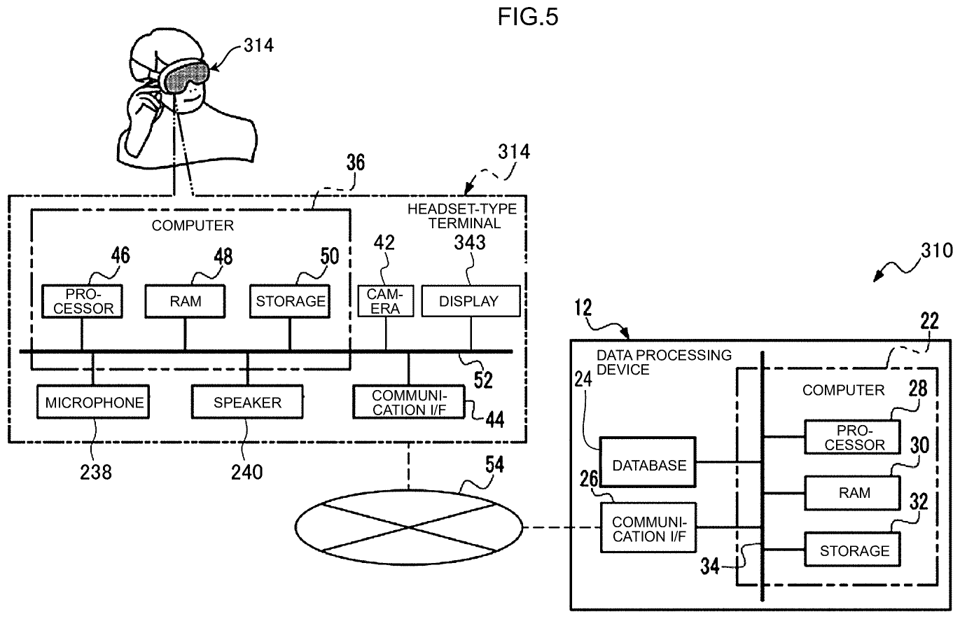

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

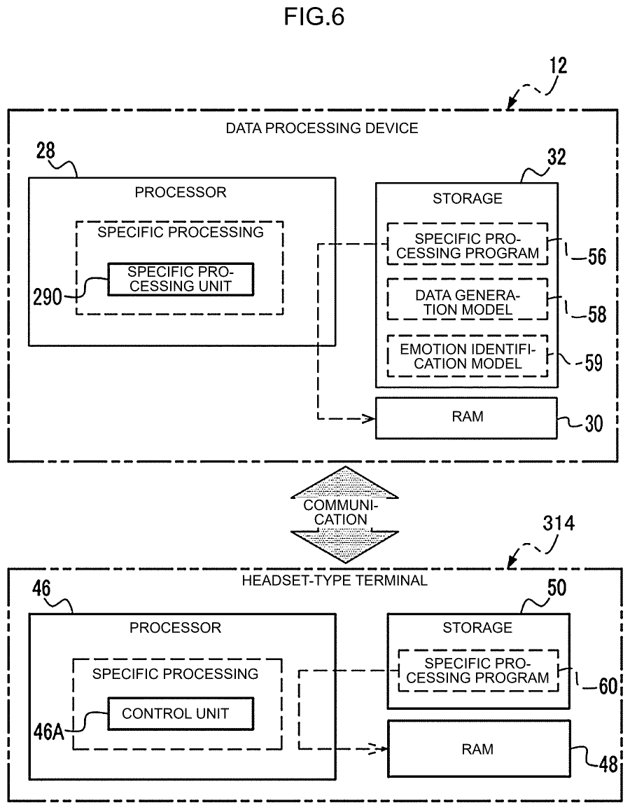

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

The correspondence between each unit and the devices or control units is not limited to the examples described above and various modifications are possible.

### Fourth Embodiment

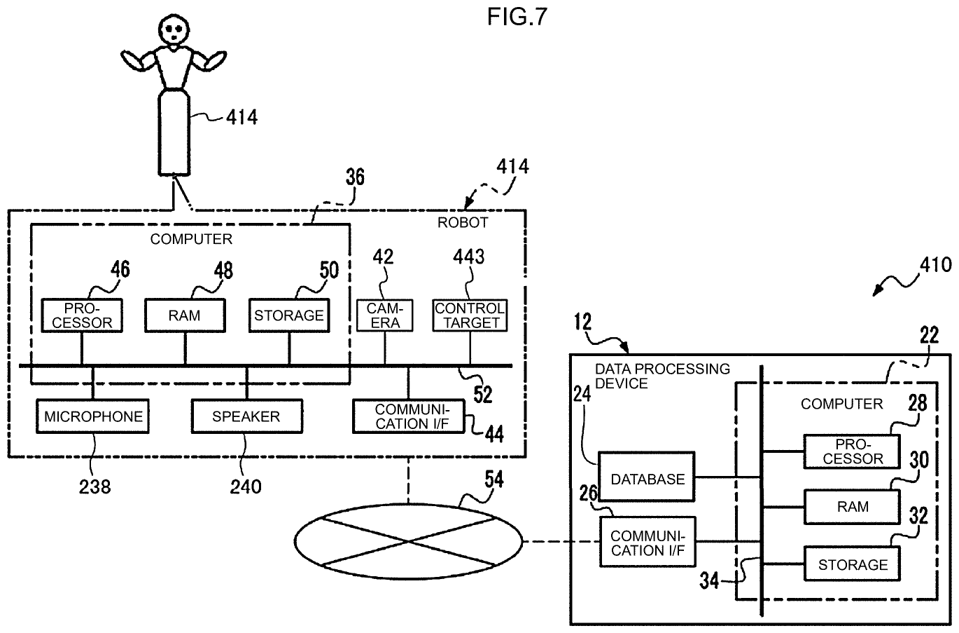

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

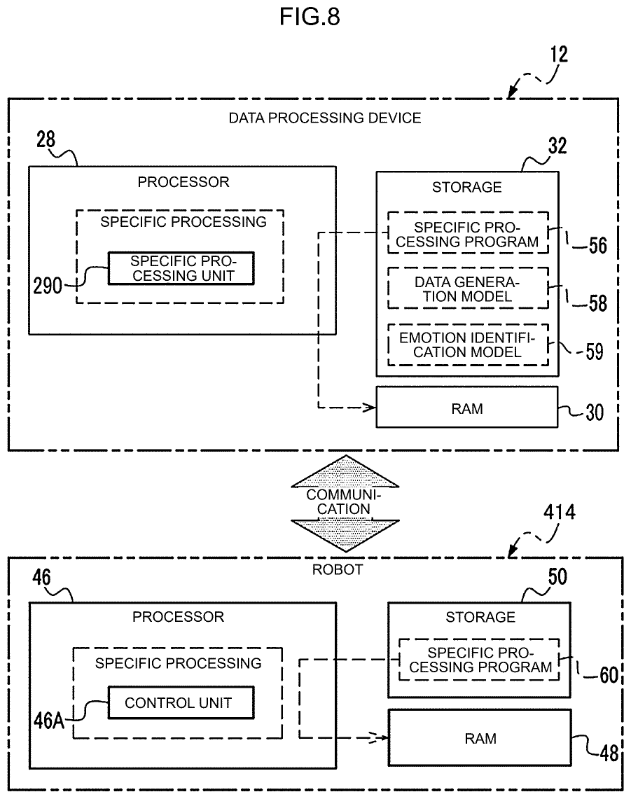

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

The correspondence between each unit and the devices or control units is not limited to the examples described above and various modifications are possible.

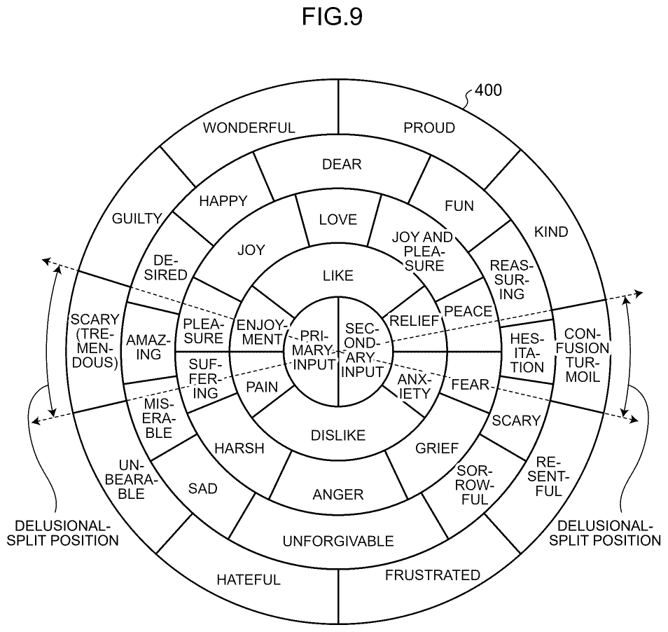

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

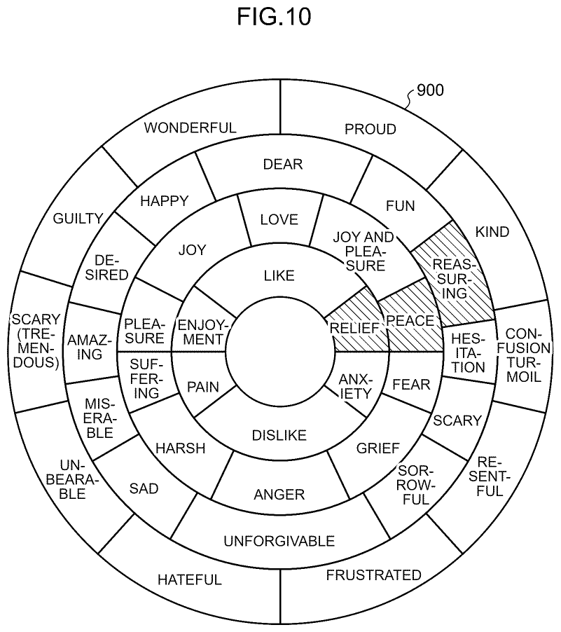

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

What is claimed is:

1. A system comprising: a surveillance camera that captures, in real time, a scene of drug administration; an analysis unit that analyzes video captured by the surveillance camera and recognizes the type and amount of the drug; and a warning unit that issues a warning when the administered amount exceeds a reference value based on the information recognized by the analysis unit.

2. The system according to claim 1, wherein the surveillance camera estimates the user's emotion and adjusts the shooting angle appropriately based on the estimated emotion of the user.

3. The system according to claim 1, wherein the surveillance camera simultaneously captures the drug administration scene and the surrounding environment to identify the cause of administration errors.

4. The system according to claim 1, wherein the surveillance camera coordinates multiple cameras to obtain images from different angles and improve analysis accuracy.

5. The system according to claim 1, wherein the surveillance camera estimates the user's emotion and adjusts the shooting frequency appropriately based on the estimated emotion of the user.

6. The system according to claim 1, wherein the surveillance camera simultaneously captures the drug administration scene and the actions of medical personnel to identify the cause of administration errors.

7. The system according to claim 1, wherein the surveillance camera uses an infrared camera in combination to enable accurate shooting even in dark places.

8. The system according to claim 1, wherein the analysis unit estimates the user's emotion and adjusts the display method of the analysis results appropriately based on the estimated emotion of the user.
